(19) United States
(12) Patent Application Publication
(10) Pub. No.: US 2025/0013434 A1
(43) Pub. Date: Jan. 9, 2025

(54) QUANTUM RANDOM NUMBER GENERATION DEVICE

(71) Applicant: Mitsubishi Electric Corporation, Tokyo (JP)

(72) Inventor: Shota Koshikawa, Tokyo (JP)

(73) Assignee: Mitsubishi Electric Corporation, Tokyo (JP)

(21) Appl. No.: 18/888,725

(22) Filed: Sep. 18, 2024

Related U.S. Application Data
(63) Continuation of application No. PCT/JP2022/017683, filed on Apr. 13, 2022.

(51) Int. Cl. G06F 7/58; H05H 3/06

(52) U.S. Cl. CPC G06F 7/588; H05H 3/06

(57) ABSTRACT

A quantum random number generation device includes: a particle generator to generate particle beams of neutral particles; a slit body to rectify the generated particle beams in a single direction; a first magnetic field applicator to convert the rectified particle beam into two first particle beams, and output the converted two first particle beams; a second magnetic field applicator to convert one of the two outputted first particle beams into two second particle beams, and output the converted two second particle beams; a particle detector to detect particles of the two outputted second particle beams; a random number generator to generate a random number using numbers of the detected particles; and a magnetic field direction controller to control the first or second magnetic field application direction based on probabilities of occurrence of the generated random number.

### CROSS REFERENCE TO RELATED APPLICATION

This application is a Continuation of PCT International Application No. PCT/JP2022/017683, filed on Apr. 13, 2022, which is hereby expressly incorporated by reference into the present application.

### TECHNICAL FIELD

The present disclosure relates to a quantum random number generation device which uses a quantum technology.

### BACKGROUND ART

Random numbers are numbers whose outcome is unpredictable and generated by an unreproducible process. Random numbers are greatly useful for applications for computer science, computer engineering, communications, information security, reliability testing for communication systems, and so on. Random number generators are roughly classified into two types: software-based random number generators and hardware-based physical random number generators. While a software-based random number is periodic, a physically-generated random number, particularly a quantumly-generated random number has a characteristic of being intrinsically random.

Among such random number generation devices which quantumly generate random numbers are random number generation devices which detect photons to generate random numbers. For example, Patent Literature 1 discloses a random number generation device which detects a photon in each polarization state to generate a random number. More concretely, Patent Literature 1 discloses a random number generation device including a polarization beam splitter, a first photon detector, and a second photon detector, in which the polarization beam splitter separates photons into photons in a vertically polarized state and photons in a horizontally polarized state, the first photon detector generates ‘1’ when detecting a photon in the vertically polarized state, and the second photon detector generates ‘0’ when detecting a photon in the horizontally polarized state. Because a photon in the vertically polarized state and a photon in the horizontally polarized state are separated at random with a predetermined probability, the random number generation device generates a random number sequence in which ‘1’s and ‘0’s appear at random.

### CITATION LIST

### Patent Literature

Patent Literature 1: JP 2003-36168 A

### SUMMARY OF INVENTION

### Technical Problem

A problem with the random number generation device of Patent Literature 1 is that the two detectors including the first and second photon detectors must be arranged at a stage following the polarization beam splitter apart from each other, and that the configuration of the detection stage is upsized.

The present disclosure is made in order to solve the above-mentioned problem, and it is therefore an object of the present disclosure to provide a quantum random number generation device that makes it possible to downsize the configuration of the detection stage.

### Solution to Problem

A quantum random number generation device according to an embodiment of the present disclosure includes: a particle generator to generate particle beams of neutral particles; a slit body to rectify the generated particle beams to a particle beam in a single direction; a first magnetic field applicator to convert the rectified particle beam into two first particle beams that are spin-polarized in directions parallel and anti-parallel to a first magnetic field application direction, and output the converted two first particle beams; a second magnetic field applicator to convert one of the two outputted first particle beams into two second particle beams that are spin-polarized in directions parallel and anti-parallel to a second magnetic field application direction, and output the converted two second particle beams; a particle detector having two regions each of which detects particles in one of the two outputted second particle beams; a random number generator to generate a random number using numbers of the detected particles; and a magnetic field direction controller to control either the first magnetic field application direction by the first magnetic field applicator or the second magnetic field application direction by the second magnetic field applicator on a basis of probabilities of occurrence of the generated random number.

### Advantageous Effects of Invention

The quantum random number generation device according to the embodiment of the present disclosure makes it possible to downsize the configuration of the detection stage.

### BRIEF DESCRIPTION OF DRAWINGS

FIG. 1 is a block diagram showing an example of the configuration of a quantum random number generation device;

FIG. 2A is a view explaining the status of the propagation of a particle beam at the time of θ=π/2 (90 degrees) when the angle which the direction in which a magnetic field is applied by a first magnetic field applicator makes with the direction in which a magnetic field is applied by a second magnetic field applicator in the quantum random number generation device is denoted by e;

FIG. 2B is a view explaining the status of the propagation of the particle beam at the time of θ=π/3 (60 degrees) when the angle which the direction in which a magnetic field is applied by the first magnetic field applicator makes with the direction in which a magnetic field is applied by the second magnetic field applicator in the quantum random number generation device is denoted by e;

FIG. 2C is a view explaining the status of the propagation of the particle beam at the time of θ=0 (0 degrees) when the angle which the direction in which a magnetic field is applied by the first magnetic field applicator makes with the direction in which a magnetic field is applied by the second magnetic field applicator in the quantum random number generation device is denoted by e;

FIG. 3A is a view showing an example of a set-up of regions P and Q when θ=π/2;

FIG. 3B is a view showing an example of the set-up of regions P and Q when θ=π/3;

FIG. 3C is a view showing an example of the set-up of regions P and Q when θ=0; and

FIG. 4 is a flowchart showing processing performed by a random number generation unit of the quantum random number generation device.

### DESCRIPTION OF EMBODIMENTS

Hereinafter, various embodiments in the present disclosure will be explained in detail while referring to the attached drawings. Components denoted by the same or like reference signs in the drawings have the same or like configurations or functions, and a repetitive explanation about such components will be omitted hereinafter.

### Embodiment 1

### <Configuration>

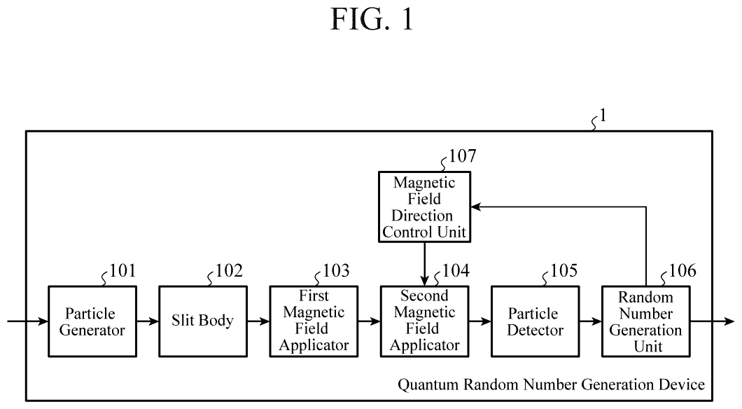

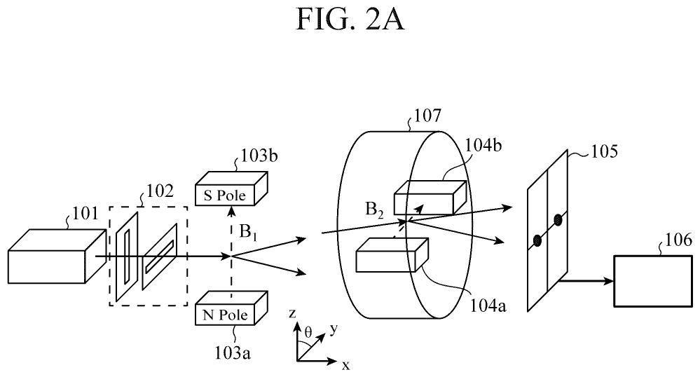

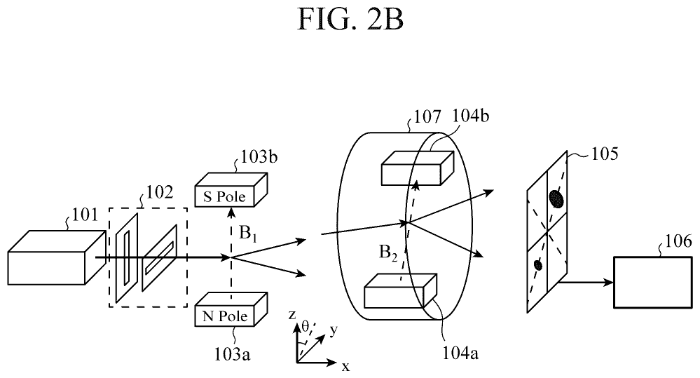

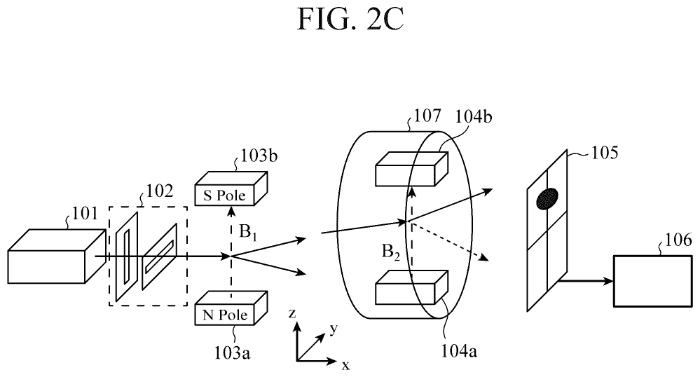

A quantum random number generation device 1 according to Embodiment 1 of the present disclosure will be explained by referring to FIGS. 1 and 2A to 2C. FIG. 1 is a view showing an example of the configuration of the quantum random number generation device 1 according to Embodiment 1 of the present disclosure. The quantum random number generation device 1 generates a particle beam and passes the omnidirectional particle beam generated thereby through a slit body, to transform the particle beam into a unidirectional particle beam, applies magnetic fields to the transformed particle beam, thereby quantizing (spin-polarizing) the particle beam in two steps, and generates a random number using the numbers of detections of particles. In order to implement this function mentioned above, the quantum random number generation device 1 includes a particle generator 101, a slit body 102, a first magnetic field applicator 103, a second magnetic field applicator 104, a particle detector 105, a random number generation unit 106, and a magnetic field direction control unit 107, as shown in FIG. 1. The quantum random number generation device 1 is used in order to generate a random number in, for example, a receiver for space optical communications (space optical communication receiver). Hereinafter, each of the components which the quantum random number generation device 1 includes will be explained in more detail.

### (Particle Generator)

The particle generator 101 is a heating furnace which heats a particle source to generate particle beams of neutral particles, and outputs the generated particle beams. It is not necessary to adjust the number of particles outputted per unit time. The particle generator 101 uses, for example, atoms of a single element, such as sodium, copper, rhodium, silver, or gold, or neutrons as the particle source. When the particle source is heated in the heating furnace, particle beams of neutral particles are generated. The particle generator 101 outputs the generated particle beams to the slit body 102. The particle beams outputted from the particle generator 101 are omnidirectional beams which travel in all directions.

### (Slit Body)

The slit body 102 rectifies the particle beams which are outputted from the particle generator 101 and travel in all directions to a particle beam in a single direction. In order to implement this function, the slit body 102 includes, for example, slit screens which are arranged in multiple stages along a traveling direction of the particle beams. For example, the slit body 102 has a configuration in which two slit screens in each of which a single slit is formed are arranged along the traveling direction of the particle beams, as shown in FIGS. 2A to 2C. The slit body 102 transforms the particles inputted thereto into a particle beam in a single direction which is limited to the slit direction, and outputs the particle beam transformed thereby to the first magnetic field applicator 103.

### (First Magnetic Field Applicator)

The first magnetic field applicator 103 applies a magnetic field to the particle beam inputted from the slit body 102, to separate and convert the particle beam into two particle beams spin-polarized in mutually opposite directions: one parallel to the magnetic field, and the other antiparallel to the magnetic field, and outputs the two converted particle beams. The first magnetic field applicator 103 includes two magnets 103a and 103b which are arranged to face each other, and which have different magnetic properties, and each of the magnets 103a and 103b includes, for example, a neodymium magnet or an electromagnet. A particle beam which is selected arbitrarily out of the two separated and spin-polarized particle beams is outputted from the first magnetic field applicator 103 to the second magnetic field applicator 104. In other words, the second magnetic field applicator 104 is placed in such a way that one of the two separated and spin-polarized particle beams which are outputted from the first magnetic field applicator 103 is inputted to the second magnetic field applicator.

### (Second Magnetic Field Applicator)

The second magnetic field applicator 104 converts the particle beam inputted from the first magnetic field applicator 103 into two spin-polarized particle beams in mutually opposite directions and outputs the two converted particle beams, under the control by the second magnetic field applicator 104. More specifically, the second magnetic field applicator 104 includes two magnets 104a and 104b having different magnetic properties, and applies a magnetic field in a direction controlled by a signal outputted from the magnetic field direction control unit 107, to separate and convert the particle beam into two particle beams spin-polarized in mutually opposite directions: one parallel to the magnetic field, and the other antiparallel to the magnetic field, and outputs the two particle beams.

The ratio of the numbers of particles in these separated and spin-polarized particle beams is determined by the angle θ which the direction of the magnetic field applied by the first magnetic field applicator 103 makes with the direction of the magnetic field applied by the second magnetic field applicator 104. The ratio of the numbers of particles, respectively, in the particle beams is expressed as cos (θ/2): sin (θ/2) with respect to the angle θ. For example, when the angle θ=0 as shown in FIG. 2C, cos0: sin0=1:0, and only one particle beam spin-polarized in the direction parallel to the magnetic field is acquired. For example, when the angle θ=π/3 as shown in FIG. 2B, cos (π/6): sin (π/6)=sqrt (3): 1. For example, when the angle θ=π/2 as shown in FIG. 2A, cos (π/4): sin (π/4)=1:1, and two particle beams spin-polarized in mutually opposite directions: one parallel to the magnetic field, and the other antiparallel to the magnetic field are acquired, and their particle numbers are equal. The two particle beams spin-polarized in mutually opposite directions: one parallel to the magnetic field, and another antiparallel to the magnetic field are outputted from the second magnetic field applicator 104 to the particle detector 105.

### (Particle Detector)

The particle detector 105 detects the particles in the particle beams inputted from the second magnetic field applicator 104, and outputs an electric signal which is based on the detection of the particles. The particle detector 105 includes, for example, a screen or an ionization device, and an electrical storage device such as a capacitor. The electric signal is outputted from the particle detector 105 to the random number generation unit 106.

### (Random Number Generation Unit)

The random number generation unit 106 generates a random number sequence on the basis of the electric signal inputted from the particle detector 105, and outputs the generated random number sequence. For example, the random number generation unit 106 generates a random number sequence which consists of random numbers each of which is one bit of a binary number of ‘0’ or ‘1’.

### (Magnetic Field Direction Control Unit)

The magnetic field direction control unit 107 outputs a signal for controlling the direction in which the magnetic field is applied by the second magnetic field applicator 104 on the basis of the probabilities of occurrence of the random numbers in the random number sequence generated by the random number generation unit 106. For example, the magnetic field direction control unit controls the direction in which the magnetic field is applied by the second magnetic field applicator 104 in such a way that the probability distributions of ‘0’ or ‘1’ in the generated random number sequence of the random numbers become equal. Because the ratio of the numbers of particles in the spin-polarized particle beams is determined by the angle θ which the direction of the magnetic field applied by the first magnetic field applicator 103 makes with the direction of the magnetic field applied by the second magnetic field applicator 104, the probability distributions of ‘0’ or ‘1’ in the generated random number sequence of the random numbers can be set freely by controlling the direction in which the magnetic field is applied by the second magnetic field applicator 104.

The random number generation unit 106 and the magnetic field direction control unit 107 are implemented by not-illustrated processing circuitry. The processing circuitry may be a processing circuit for exclusive use, or may be a processor which executes a program stored in a memory.

In the case where the processing circuitry is a processing circuit for exclusive use, the processing circuit for exclusive use is, for example, a single circuit, a composite circuit, a programmable processor, a parallel programmable processor, an application specific integrated circuit (ASIC), a field-programmable gate array (FPGA), or a combination of these circuits.

In the case where the processing circuitry is a processor, the random number generation unit 106 and the magnetic field direction control unit 107 are implemented by software, firmware, or a combination of software and firmware. The software and the firmware are described as programs and the programs are stored in a memory. The processor implements the functions of the in a memory, random number generation unit 106 and the magnetic field direction control unit 107 by reading and executing the programs stored in the memory. Here, examples of the memory include a non-volatile or volatile semiconductor memory, such as a random access memory (RAM), a read-only memory (ROM), a flash memory, an erasable programmable read only memory (EPROM), or an electrically erasable programmable read-only memory (EEPROM), a magnetic disc, a flexible disc, an optical disc, a compact disc, a mini disc, or a DVD.

### <Operation>

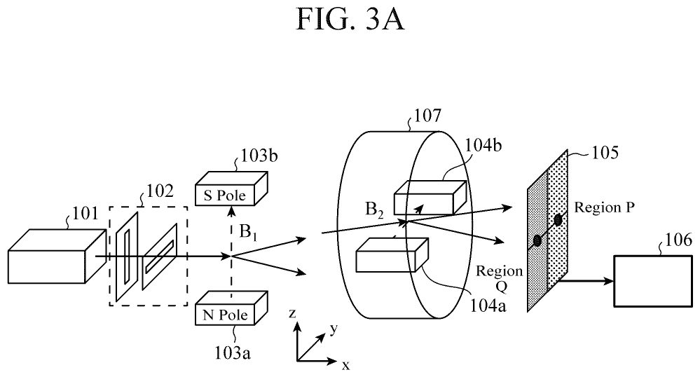

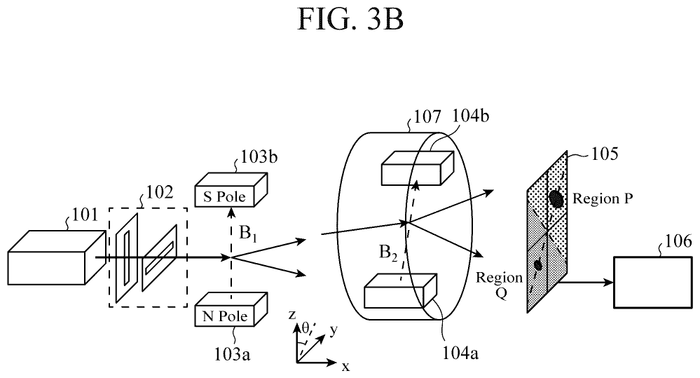

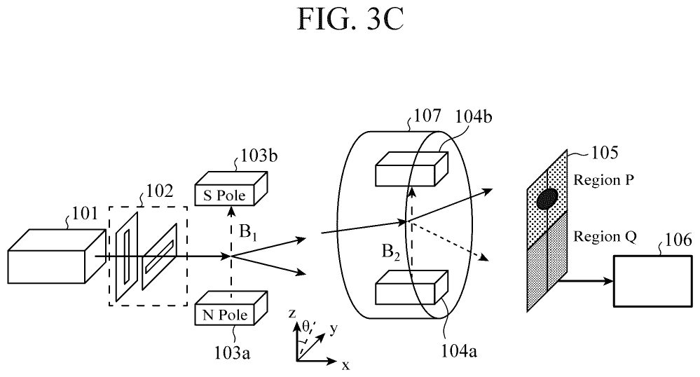

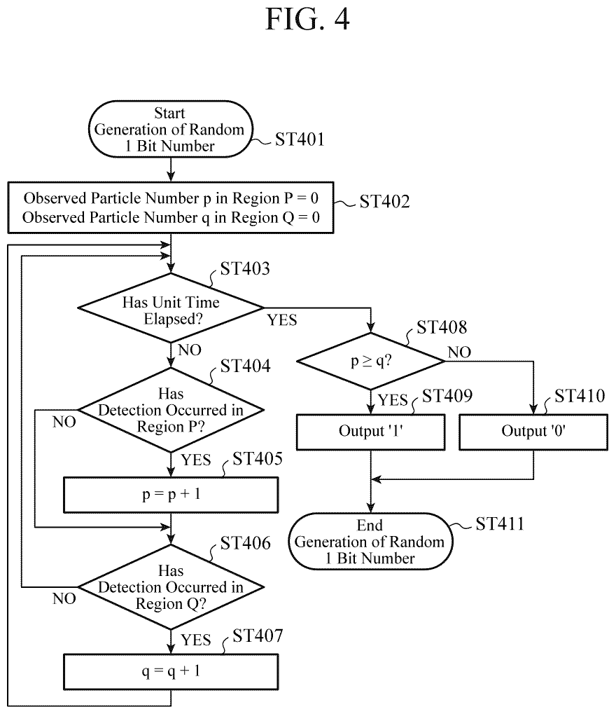

Next, the random number generating operation performed by the random number generation unit 106 of the quantum random number generation device 1 will be explained by referring to FIGS. 3A to 3C, and 4. Here, it is assumed that a screen is used as the particle detector 105, the center of the screen is aligned with the center position of the second magnetic field applicator 104 along an x direction of FIG. 2, and the screen is placed in parallel with a yz plane. At this time, considering that the screen is divided by a straight line having an inclination in a direction perpendicular to the magnetic field applied by the second magnetic field applicator 104, and passing through the center of the screen, one of the regions on the screen after division is denoted by a region P and the other one of the regions on the screen after division is denoted by a region Q. As an example, the region P and the region Q are set up as shown in FIG. 3A when the angle θ=π/2. As an example, the region P and the region Q are set up as shown in FIG. 3B when the angle θ=π/3. As an example, the region P and the region Q are set up as shown in FIG. 3C when the angle θ=0.

FIG. 4 is a view showing a flow of the random number generating operation performed by the random number generation unit 106. In brief, the random number generation unit 106 compares the number p of particle detections per unit time in the region P and the number q of particle detections per unit time in the region Q, and generates a random number on the basis of a result of the comparison.

In step ST401, the generation of random 1 bit number is started. The observed particle number p for the region P and the observed particle number q for the region Q at this time are initialized to 0 (step ST402).

In step ST403, whether or not a unit time T has elapsed is determined. When a unit time T has not elapsed, whether a particle has been detected in the region P is judged (step ST404). When a particle has been detected in the region P, p is incremented by one (step ST405) and the processing proceeds to step ST406. When no particle has been detected in the region P, no operation is performed on p and the processing proceeds to step ST406.

In step ST406, whether a particle has been detected in the region Q is judged. When a particle has been detected in the region Q, q is incremented by one (step ST407) and the processing returns to step ST403. When no particle has been detected, the processing returns to step ST403 in which to determine whether a unit time T has elapsed, without performing any operation on q.

When it is determined in step ST403 that a unit time T has elapsed, p and q are compared to determine whether or not p is greater than or equal to q (step ST408). When p is greater than or equal to q, ‘1’ is outputted as the random number (step ST409). When p is less than q, ‘0’ is outputted as the random number (step ST410). When the random number is outputted in step ST409 or ST410, the generation of random 1 bit number is ended (step ST411).

The ratio of ‘0’ and ‘1’ in this random number is equal to the ratio of the numbers of particles in the two particle beams spin-polarized in mutually opposite directions which are outputted from the second magnetic field applicator 104, i.e. cos (θ/2): sin (θ/2). Because this angle θ can be continuously adjusted with h a command from the magnetic field direction control unit 107, the distributions of the probabilities of occurrence of ‘0’ or ‘1’ in the random number sequence which consists of multiple bits can be controlled.

Because the quantum random number generation device 1 is configured as mentioned above, the quantum random number generation device 1 does not need multiple photon detectors. Therefore, the size and cost of the quantum random number generation device 1, particularly the detection stage of the quantum random number generation device 1 can be reduced to less than those of conventional quantum random number generation devices. Further, it is possible to control the probability distributions of the random number sequence by controlling the angle θ using the signal from the magnetic field direction control unit 107.

### Modified Embodiments

In the above explanation, the embodiment in which the magnetic fields are applied to the particle beam of neutral particles in two steps by the first magnetic field applicator 103 and the second magnetic field applicator 104, and the direction of the second magnetic field applied by the second magnetic field applicator 104 is made to be variable is explained.

In another embodiment, the direction of the first magnetic field applied by the first magnetic field applicator 103 may be made to be variable. Even by changing the direction of the first magnetic field with respect to the direction of the second magnetic field, the angle θ which the direction of the first magnetic field makes with the direction of the second magnetic field can be changed.

In a further embodiment, both the direction of the first magnetic field applied by the first magnetic field applicator 103 and the direction of the second magnetic field applied by the second magnetic field applicator 104 may be made to be variable.

### <Additional Remarks>

Some aspects of the various embodiments explained above will be summarized as follows.

### (Additional Remark 1)

A quantum random number generation device of Additional Remark 1 includes: a particle generator (101) to generate particle beams of neutral particles; a slit body (102) to rectify the generated particle beams to a particle beam in a single direction; a first magnetic field applicator (103) to convert the rectified particle beam into two first particle beams that are spin-polarized in directions parallel and anti-parallel to a first magnetic field application direction, and output the converted two first particle beams; a second magnetic field applicator (104) to convert one of the two outputted first particle beams into two second particle beams that are spin-polarized in directions parallel and anti-parallel to a second magnetic field application direction, and output the converted two second particle beams; a particle detector (105) having two regions each of which detects particles in one of the two outputted second particle beams; a random number generation unit (106) to generate a random number using numbers of the detected particles; and a magnetic field direction control unit (107) to control either the first magnetic field application direction by the first magnetic field applicator or the second magnetic field application direction by the second magnetic field applicator on a basis of probabilities of occurrence of the generated random number.

### (Additional Remark 2)

A quantum random number generation device of Additional Remark 2 is one which has the configuration described in Additional Remark 1, and in which the random number is a random 1 bit binary number of ‘0’ or ‘1’, and wherein the magnetic field direction control unit controls probability distributions of ‘0’ or ‘1’ in a random number sequence of random numbers to be generated by changing either the first magnetic field application direction by the first magnetic field applicator or the second magnetic field application direction by the second magnetic field applicator.

It is possible to combine embodiments, and to modify and omit each embodiment as appropriate.

### INDUSTRIAL APPLICABILITY

The quantum random number generation device according to the present disclosure is used in order to generate random numbers in, for example, space optical communication receivers.

### REFERENCE SIGNS LIST

1 quantum random number generation device, 101 particle generator, 102 slit body, 103 first magnetic field applicator, 103a magnet, 103b magnet, 104 second magnetic field applicator, 104a magnet, 104b magnet, 105 particle detector, 106 random number generation unit, and 107 magnetic field direction control unit.

1. A quantum random number generation device comprising:
a particle generator to generate particle beams of neutral particles;
a slit body to rectify the generated particle beams to a particle beam in a single direction;
a first magnetic field applicator to convert the rectified particle beam into two first particle beams that are spin-polarized in directions parallel and anti-parallel to a first magnetic field application direction, and output the converted two first particle beams;
a second magnetic field applicator to convert one of the two outputted first particle beams into two second particle beams that are spin-polarized in directions parallel and anti-parallel to a second magnetic field application direction, and output the converted two second particle beams;
a particle detector having two regions each of which detects particles in one of the two outputted second particle beams;
a random number generator to generate a random number using numbers of the detected particles; and
a magnetic field direction controller to control either the first magnetic field application direction by the first magnetic field applicator or the second magnetic field application direction by the second magnetic field applicator on a basis of probabilities of occurrence of the generated random number.

2. The quantum random number generation device according to claim 1, wherein the random number is a random 1 bit binary number of ‘0’ or ‘1’, and wherein the magnetic field direction controller controls probability distributions of ‘0’ or ‘1’ in a random number sequence of random numbers to be generated by changing either the first magnetic field application direction by the first magnetic field applicator or the second magnetic field application direction by the second magnetic field applicator.
